(19) United States
(12) Patent Application Publication
(10) Pub. No.: US 2008/0250245 A1
(43) Pub. Date: Oct. 9, 2008

(54) Biometric-based document security

(76) Inventors: Daniel O. Sanderson, New Richmond, WI (US); Joel D. Sanderson, New Richmond, WI (US)

Correspondence Address: WESTMAN CHAMPLIN & KELLY, P.A., SUITE 1400, 900 SECOND AVENUE SOUTH, MINNEAPOLIS, MN, 55402-3244, US

(21) Appl. No.: 11/906,301

(22) Filed: Oct. 1, 2007

Related U.S. Application Data
(60) Provisional application No. 60/849,567, filed on Oct. 5, 2006.

(51) Int. Cl. H04L 9/06

(52) U.S. Cl. 713/169

(57) ABSTRACT

Embodiments of methods and systems for securely transmitting electronic data are disclosed. One embodiment of a method includes a security server authenticating the identity of a sender utilizing a collection of biometric data obtained from the sender. A sender client encrypts electronic data with an encryption key obtained from the security server upon successful authentication. A data transmission server transmits the encrypted electronic data from the sender client to a receiver client. The document security server authenticates the identity of a receiver utilizing a collection of biometric data obtained from the receiver. The security server sends encryption information related to the encryption key to the receiver client upon successful authentication of the receiver. Finally, the receiver client decrypts the encrypted electronic data utilizing the encryption information.

### REFERENCE TO RELATED CASE

The present application claims priority of U.S. provisional patent application Ser. No. 60/849,567, filed Oct. 5, 2006, the content of which is hereby incorporated by reference in its entirety.

### BACKGROUND

Electronic mail, commonly referred to as e-mail, is a popular form of communication. E-mail is widely used throughout the world for people to transmit information to one another. There are however several shortcomings with e-mail.

One shortcoming with e-mail is that the true identities of e-mail senders and receivers are not verified. E-mail systems commonly only require a user to provide a password to gain access. These systems are not truly verifying users. They are only verifying that the person trying to gain access knows a correct password. E-mail passwords can easily be compromised by people guessing a user's password, intercepting a password using malicious software, or any number of methods devised by “hackers.”

Another shortcoming with e-mail is privacy. E-mail is commonly transmitted over unsecured networks. This allows for people to intercept e-mails and to access their content. E-mail is also commonly transmitted using third party servers. System administrators can easily access the content of e-mails sent using their servers. Some servers also commonly store e-mail. This allows for system administrators or anyone else who can properly or improperly access the systems to retrieve and access e-mail.

### SUMMARY

Embodiments of methods and systems for securely transmitting electronic data are disclosed. One embodiment of a method includes a security server authenticating the identity of a sender utilizing a collection of biometric data obtained from the sender. A sender client encrypts electronic data with an encryption key obtained from the security server upon successful authentication. A data transmission server transmits the encrypted electronic data from the sender client to a receiver client. The security server authenticates the identity of a receiver utilizing a collection of biometric data obtained from the receiver. The security server sends encryption information related to the encryption key to the receiver client upon successful authentication of the receiver. Finally, the receiver client decrypts the encrypted electronic data utilizing the encryption information.

### BRIEF DESCRIPTION OF THE DRAWINGS

FIG. 1 is a block representation of an exemplary computing environment.

FIG. 2 is a schematic diagram of a biometric-based document security system.

FIG. 3 is a flow chart illustrating a method for providing a biometric-based security system.

FIG. 4 is a flow chart illustrating a method for providing a biometric-based security system.

### DETAILED DESCRIPTION

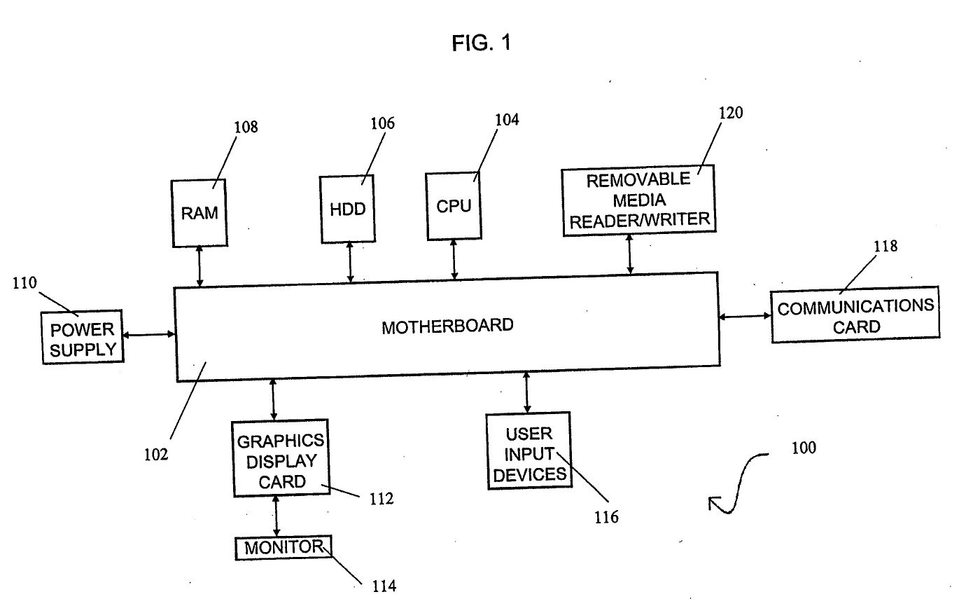

Certain embodiments described herein are intended for implementation in association with computing devices such as, but not limited to, a personal computer, a laptop computer, a personal digital assistant, or a server. FIG. 1 is a block diagram of one example of a suitable computing device 100. Computing device 100 is only one example of a suitable device and is not intended to suggest any limitation as to the scope of use or functionality of the claimed subject matter. Neither should computing device 100 be interpreted as having any dependency or requirement relating to any one or combination of illustrated components.

Computing device 100 includes a motherboard 102, a central processing unit 104, a hard disk drive 106, random access memory 108, a power supply 110, a graphics display card 112, a monitor 114, user input devices 116, a communications card 118, and removable media reader/writer 120. Hard disk drive 106 is configured to write information to, and read information from computer readable storage media. Random access memory 108 is also configured to write information to, and read information from computer readable storage media. Removable media reader/writer 120 is configured to write information to, and read information from removable media such as, but not limited to, a magnetic disk, an optical disk, and/or flash memory. User input devices 116 are configured to receive various inputs from a user. Devices 116 can include, but are not limited to, a keyboard, a mouse, a touch screen, and/or a microphone. Communications card 118 enables computing device 100 to transfer data to and from other electronic devices. Graphics display card 112 generates graphical image information and outputs the information such that it can be viewed on a monitor. Monitor 114 receives a signal from graphics display card 112 and displays visual images on its screen for a user to view. Central processing unit 104 executes computer program instructions and processes data. Motherboard 102 provides electrical and logical connections by which the other components of the system communicate. For example, motherboard 102 allows the central processing unit 104 to read data from, and write data to random access memory 108. Finally, power supply 110 provides for the electrical requirements of computing device 100. For example, electricity needed to operate hard disk drive 106 and monitor 114 illustratively originates from power supply 110. In one embodiment, the illustrated computer also includes a biometric input device, such as a fingerprint reader.

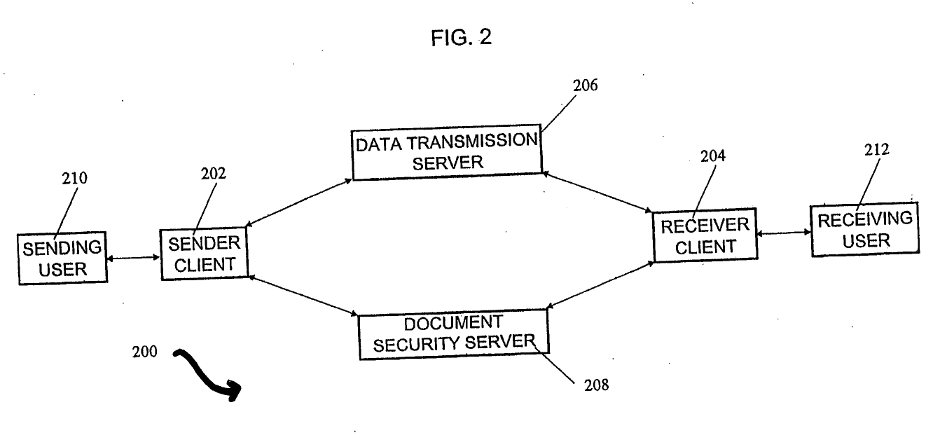

FIG. 2 is a schematic diagram of an embodiment of a biometric-based document security system 200. System 200 includes a sender client 202, a receiver client 204, a data transmission server 206, a document security server 208, a sending user 210, and a receiving user 212. The clients and servers are illustratively implemented in the context of a computing system such as but not limited to computing device 100. Clients 202 and 204 are configured to send and receive data to and from servers 206 and 208. In an embodiment, the clients have unsecured network connections to data transmission server 206, and have secured network connections to document security server 208. Clients 202 and 204 are also configured to collect biometric samples such as, but not limited to, fingerprint or iris samples from user input devices 116, and to generate electronic representations of those samples using central processing unit 104. Data transmission server 206 is configured to receive electronic communications such as e-mails from sender client 202 and to transmit them to receiver client 204. Server 206 is also optionally configured to store electronic communications sent from client 202 on its storage mediums such as a hard disk drive 106 or on removable media utilizing reader/writer 120. Embodiments of data transmission server 206 include servers provided by third-party e-mail service providers. It should be noted that the encrypted message does not need to be sent through an e-mail system specifically; it can be any type of transmission such as but not limited to ftp, filing sharing, etc. Document security server 208 is configured to send and receive data from clients 202 and 204. As mentioned previously, in an embodiment, the communications between server 208 and clients 202 and 204 are transmitted over a secured network. Document security server 208 is also configured to generate and store encryption keys, and to store and analyze biometric samples. Sending user 210 is illustratively a person that wishes to send a message from sender client 202 to receiving user 212. Receiving user 212 is illustratively a person receiving a message from user 210 and using receiver client 204.

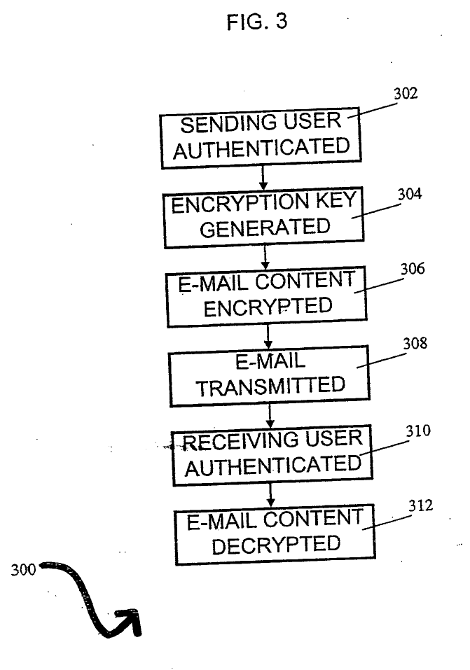

FIG. 3 is a flow chart illustrating an embodiment, in very general terms, of a method 300 for providing a biometric-based security system. In accordance with block 302, a sending user 210 who wishes to send an e-mail to a receiving user 212, first authenticates his or herself with document security server 208 by submitting a biometric sample such as a fingerprint, that is compared with a stored representation of a previously submitted biometric sample. In accordance with block 304, upon successful authentication, server 208 transmits a unique encryption key to sender client 202. In accordance with block 306, the sender client 202 uses the unique encryption key to encrypt the message content. In accordance with block 308, data transmission server 206 then transmits the encrypted message from sender client 202 to receiver client 204. In accordance with block 310, receiving user 212 then authenticates his or herself with document security server 208 by submitting a biometric sample that is compared with a stored representation of a previously submitted biometric sample. In accordance with block 312, if receiving user 212 is successfully authenticated, server 208 transmits a decryption key corresponding to the unique encryption key that receiver client 204 utilizes to decrypt the e-mail content.

It is worth noting some of the features of method 300. First, both the sending user 210 and the receiving user 212 are authenticated. This ensures that only the intended recipient(s) of the document is able to decrypt the document. This also ensures that the recipient of the document is able to reliably know who the true sender of the document is. Second, the document is never transmitted in an unencrypted state. This prevents system administrators such as third-party e-mail providers from storing and being able to access the content. This also prevents anyone who may intercept the document to be able to access the content.

Another noteworthy feature of method 300 is that it is compatible with widely available and used data transmission systems including transmitting data over multiple third-party e-mail service providers. For example, sending user 210 and receiving user 212 can have e-mail accounts with different service providers. In this situation, the users have the convenience of using their normal e-mail providers while maintaining privacy and being able to accurately rely on the authenticity of the user and receiver's identities. Without method 300, the document would not be private and the users' identities would not be authenticated.

Method 300 can also be used with any type of e-mail software such as local e-mail clients and web-based e-mail. Some embodiments used with local e-mail clients include “plug-ins” or “add-ins.” For example, a “plug-in” embodiment can be used to send and receive secured e-mail utilizing the local e-mail client interface. In another embodiment, if a receiving user 212 does not have the appropriate software, a web-link or instructions are provided such that user 212 can obtain the needed software.

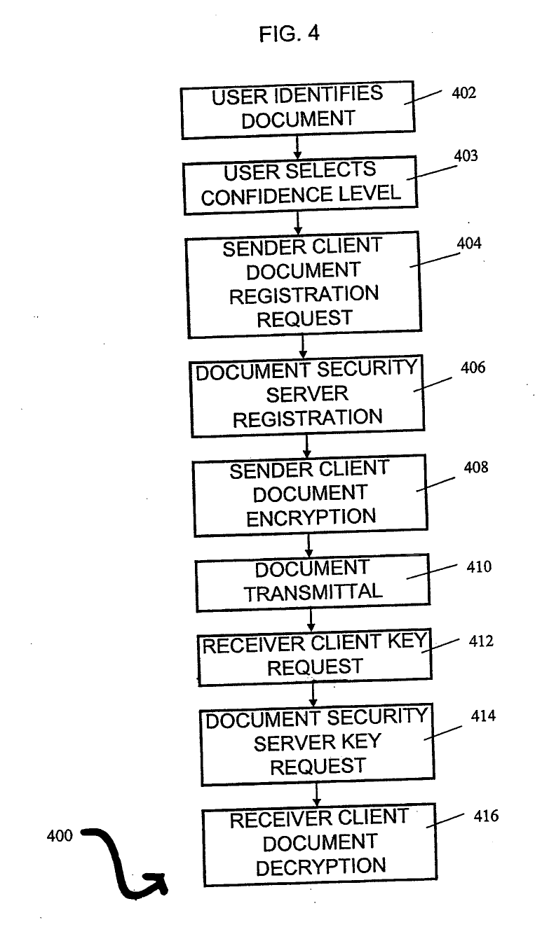

FIG. 4 is a flow chart illustrating an embodiment of a method 400, in more detailed terms, for providing a biometric-based security system. In accordance with block 402, sending user 210 identifies a document to send from sender client 202 to receiving user 212. The term document is meant in a very broad sense. The document can be any type of electronically storable data such as text, pictures, video, or computer executable code. In an embodiment, user 210 has previously generated an enrollment account with document security server 208. The account illustratively includes a user identifier such as a username and a biometric match template. Embodiments of biometric match templates are generated by user 210 submitting a biometric sample to a user input device 116 and the document security server 208 storing a representation of the sample on its hard disk drive 106 or on another computer readable medium. Certain embodiments of method 300 will be discussed in terms of fingerprint biometric samples. Any type of biometric sample such as iris, retina, or facial characteristics can of course be used.

In accordance with block 403, after the sending user 210 has identified a document to send, user 212 optionally selects a confidence level (or confidence metric) for the receiver authentication. If a document includes very private information such as personal medical history or financial information, the sender may select a high confidence level for receiver authentication. Using the high confidence level would reduce the probability of a false successful authentication (i.e. someone other than the intended receiver being deemed authenticated as the intended receiver). Alternatively, if a document includes less private information such as inventory levels of a department store, the sender may select a lower confidence level. Using the lower confidence level would reduce the probability of the intended receiver being unsuccessful in authenticating him or herself with the system. In another embodiment, the confidence level (or confidence metric) for sender authentication is also optionally selected.

In accordance with block 404, after the sending user 210 has selected a confidence level, user 210 sends from the sender client 202 to the document security server 208 a document registration request. The document registration request illustratively includes identifiers of the sender 210 and of the receiver 212 such as previously generated usernames or account numbers. In an embodiment, once a request is made, server 208 transmits a message to client 202 to prompt user 210 for a biometric sample. User 210 illustratively submits a biometric sample corresponding to the biometric sample submitted during enrollment (i.e. if a right index fingertip print was submitted during enrollment, the user would submit the same right index fingertip print for document registration).

In accordance with block 406, document security server 208 performs document registration. Server 208 compares the user identifier received from client 202 to user identifiers stored in its database. In an embodiment, if the user identifier does not match an enrolled user identifier, an error message is returned to client 210 and optionally displayed to user 210 on a monitor 114. If the user identifier does match an enrolled user identifier, server 208 authenticates user 210 by comparing the biometric sample sent in the document registration request packet to the biometric sample submitted during user enrollment. If the biometric sample does not match the enrollment sample within a certain level of confidence, the user is deemed to not be the authentic user. In this case, the user will not be able to continue the process. An error message may be sent back to client 202 or a message may be sent back requesting another biometric sample. If the biometric sample does match the enrollment sample within a certain level of confidence, the user is deemed authenticated and the process continues. It should be noted that the level of confidence required for a match is adjustable. If very important, highly secret information is to be sent, the system may require a very close match. If less security is required, a lower level of confidence may be used.

After document security server 208 successfully verifies the user identifier and authenticates the identity of the sender by comparing the biometric sample with the one that was stored when the sender enrolled into the system, server 208 generates an encryption key and a document identifier. In embodiments, the encryption key is private and is a unique encryption key such as a private one-time random key. The document identifier is a unique identifier and optionally public. In an embodiment, server 208 associates and stores electronic copies of the document identifier, the sender identifier, the receiver identifier, and the key, such that if the document identifier is submitted to server 208, it will be able to determine the associated sender, receiver, and key. Server 208 then sends the key and document identifier to sender client 202.

In accordance with block 408, sender client 202 performs document encryption. Client 202 receives the document identifier and encryption key from server 208. Client 202 encrypts the document identified in block 402 utilizing the encryption key received from server 208. The document can optionally be compressed before it is encrypted.

In accordance with block 410, sender client 202 transmits the encrypted document and document identifier to receiver client 204. In an embodiment, a data transmission server 206 is used to transmit the information from client 202 to client 204. In an embodiment, clients 202 and 204 are connected to server 206 using unsecured lines and sever 206 is an unsecured third-party e-mail service provider. It should be noted that the encrypted document may be transmitted though other means such as, but not limited to, ftp, file sharing, etc. In other embodiments, the encrypted document is transmitted utilizing computer readable/writeable media such as optical disks or flash memory. It is worth noting that although the encrypted document is sent over unsecured networks or using unsecured servers, the contents of the document remain private. System administrators or message transmittal interceptors that could otherwise view the information are now prevented from doing so, and the information remains private.

In accordance with block 412, after receiver client 204 has received the encrypted document and document identifier, client 204 submits the document identifier and a key request to document security server 208. Client 204 prompts receiving user 212 for his or her user identifier and a biometric sample. In an embodiment, user 212 has previously generated an enrollment account with server 208 in a similar manner as to how user 210 has enrolled. The enrollment account illustratively includes a user identifier such as a username and a biometric match template. Receiver client 204 then transmits the biometric sample and user identifier provided by user 212 to document security server 208.

In accordance with block 414, document security server 208 performs the key request. Server 208 verifies that the user identifier of user 212 is valid and properly enrolled. Server 208 then compares the biometric sample of user 212 to the biometric data stored in its database. If there is no match, an error message is optionally returned to client 204. If biometric sample matches the enrollment biometric sample within a certain confidence level (e.g., a level of confidence selected by the sender), user 212 is authenticated. If user 212 is authenticated, server 208 retrieves the encryption key previously stored and associated with the document identifier. Server 208 also optionally retrieves the demographic data such as name and organization of the sender, user 210. Server 208 then sends the encryption key (or other related corresponding key needed for decryption) and sender information to receiver client 204.

In accordance with block 416, receiver client 204 performs document decryption. Client 204 receives the encryption key (or corresponding key) from server 208 and utilizes it to decrypt the encrypted document. Client 204 makes the now decrypted document available to user 212. Client 204 optionally also provides to user 212 the sender information.

Method 400 and what has been previously discussed are of course only exemplary embodiments. Other embodiments are of course possible. For example, in one embodiment, only a document sender needs to enroll with a documentation security server and document receivers need not enroll with the document security server. This would allow for receivers of documents to authenticate the sender and receive encrypted messages, while providing the convenience of receivers not having to enroll with the system. In another embodiment, only a document receiver needs to enroll with a document security server. This would allow for a sender of a document to authenticate the recipient of a document and send encrypted documents, while providing the convenience of the sender not having to enroll. In yet another embodiment, neither the sender nor receiver need to enroll. This would allow for encrypted documents to be sent to ensure privacy, while providing the convenience of senders and receivers not having to enroll.

It is also worth noting that although systems with multiple servers have been described, that single server systems are also included in embodiments. One server could be used as both the document security server and as the data transmission server. This would provide the convenience of being able to authenticate users and data privacy, without needing another server for data transmission.

Finally, it is worth noting that the methods and systems described can be used along with other methods and systems for user authentication and privacy. A user may already have a client that requires authentication before access is allowed, and also have a data transmission system that requires authentication for access. System 200 and method 400, and other embodiments described and their equivalents can be used along with a user's existing authentication and privacy systems to provide even greater security and privacy. Alternatively, of course, a user with existing authentication and privacy systems can discontinue their use, and use a system such as system 200 or method such as method 400 to provide authentication and privacy while providing greater user convenience and lower system maintenance. It is to be understood that the described embodiment of the present invention are not limited to application in the context of fingerprint biometrics. The same systems and methods could just as easily be employed in the context of voice, hand, handwriting, vein, or any other biometrics.

Although the biometric-based document security system and methods have been described with reference to particular embodiments, workers skilled in the art will recognize that changes may be made in form and detail without departing from the spirit and scope of the invention.

What is claimed is:

1. A method for transmitting electronic data, the method comprising:
authenticating the identity of a sender utilizing a collection of biometric data obtained from the sender;
transmitting an encryption key to a client system associated with the sender;
authenticating the identity of a receiver utilizing a collection of biometric data obtained from the receiver; and
transmitting a corresponding decryption key to a client system associated with the receiver, wherein the corresponding decryption key enables decryption of data encrypted with the encryption key.

2. The method of claim 1, wherein authenticating the identity of a receiver includes applying a confidence metric selected by the sender.

3. The method of claim 1, the method further comprising:
generating a document identifier that includes information associating the sender, the receiver, and the encryption key.

4. The method of claim 1, wherein the encryption key and the corresponding decryption key are the same.

5. The method of claim 1, wherein the encryption key and the corresponding decryption key are different.

6. The method of claim 1, wherein the encryption key and the corresponding decryption key are different but related.

7. The method of claim 1, wherein authenticating the identity of a sender utilizing a collection of biometric data comprises utilizing a collection of facial characteristics.

8. The method of claim 1, wherein authenticating the identity of a receiver utilizing a collection of biometric data comprises utilizing a collection of retina characteristics.

9. A method for transmitting electronic data, the method comprising:
receiving, from a remote source, encrypted electronic content;
transmitting, to a remote server, a collection of biometric data as evidence of authorization to access a decryption key;
receiving the decryption key; and
utilizing the decryption key to decrypt the encrypted electronic content.

10. The method of claim 9, wherein the remote source and the remote server are not the same.

11. The method of claim 9, wherein the remote source and the remote server are the same.

12. The method of claim 9, wherein receiving the decryption key is contingent upon satisfying a confidence metric selected by a sender.

13. The method of claim 9, the method further comprising:
receiving demographic data from the remote server.

14. The method of claim 13, wherein demographic data comprises sender information.

15. A system for transmitting electronic data, the system comprising:
a sender client that collects a biometric sample from a sending user and encrypts a collection of data utilizing an encryption key;
a receiver client that collects a biometric sample from a receiving user and decrypts the collection of data utilizing a decryption key that corresponds to the encryption key, wherein the corresponding decryption key enables decryption of data encrypted with the encryption key; and
a security server that receives the biometric sample from the sender client and transmits the encryption key to the sender client only if the sample from the sender client is successfully authenticated; and
wherein the security server also receives the biometric sample from the receiver client and transmits the corresponding decryption key only if the sample from the receiver client is successfully authenticated.

16. The system of claim 15, the system further comprising:
a data transmission server that transmits the encrypted collection of data from the sender client to the receiver client.

17. The system of claim 16, wherein the data transmission server transmits the encrypted collection of data from the sender client to the receiver client over unsecured lines.

18. The system of claim 16, wherein the data transmission server comprises multiple third-party servers.

19. The method of claim 15, wherein the document security server authenticates the biometric sample received from the receiver client in light of a confidence metric.

20. The method of claim 19, wherein the confidence metric is selected by the sending user.
